(19) United States
(12) Patent Application Publication
(10) Pub. No.: US 2008/0016134 A1
(43) Pub. Date: Jan. 17, 2008

(54) Methods and apparatuses to find a median of a set of values

(75) Inventors: Robert Klima, Vienna (AT); Alois Hahn, Vienna (AT)

Correspondence Address: Alan Carlson, 6202 Lynn Lane, Lago Vista, TX, 78645, US

(73) Assignee: On Demand Microelectronics

(21) Appl. No.: 11/825,357

(22) Filed: Jul. 7, 2007

Related U.S. Application Data
(60) Provisional application No. 60/806,953, filed on Jul. 11, 2006.

(51) Int. Cl. G06F 7/24

(52) U.S. Cl. 708/202

(57) ABSTRACT

Methods and apparatuses that can determining a median value from a set of m values are disclosed. The method can include receiving a set of values, separating the set of values into subsets where some subsets have multiple values and at least one other has a single value. The subsets having multiple variables can be sorted based on the magnitudes of the multiple values. The values from the subset can be processed to find sub-median values, and a median value can be determined from the set of values utilizing the sub-median values and sorted values. Other embodiments are also disclosed.

### CROSS-REFERENCE TO RELATED APPLICATION

The disclosed invention is related to the subject matter of provisional United States Patent Application entitled Method And Apparatus To Find The median of a Set of unsorted Values filed Jul. 11, 2006 Application No. 60,806,953. Applicant hereby claims the benefit of such filing under 35 U.S.C. Sec. 119(e) of the provisional application. The contents of the provisional application are hereby incorporated by reference in their entirety.

### FIELD OF THE INVENTION

The invention relates to methods and arrangements for determining a median value from of a set of received values.

### BACKGROUND OF THE INVENTION

The process of finding a median value from a set of values is a mathematical function. This mathematical function can be classified as a statistical function. The process of finding a median from a set of values is often utilized in graphical algorithms that process video data. Hence, finding a median in streaming video is a common function performed by processors that process graphical information and performing such a process most efficiently can provide significant benefits. A median function can return a median value M (or in short the median) from a plurality of numbers, a data set or a set of values.

When a data set has an odd number of values, the median value is the actual number in the data set that is the “middle value.” Thus, for a given a set of m values where m is odd, the median function can return the value M which has (m−1)/2 values that are less than or equal to M and (m−1)/2 values that are greater than or equal to M. For example, if a data set contains nine values and no duplicate values four values will be larger than M and four values will be smaller than M. If m is an odd number, M can be part of the set of input values. If m is an even number, M can be calculated as the mean value of the two middle values or can be calculated as a value that is halfway between the middle two values.

There are a number of existing processes utilized by graphical processing systems to determine a median value from a set of values. The most common methods sort a data set based on the value or magnitude of the numbers and then choose the value that is the middle value. These traditional approaches often have built combinational logic that requires a relatively large number of logic gates or circuitry and finding a median from a set of values typically requires several clock or processing cycles. Thus, although finding a median value is not extremely complex the portion of a graphical processor that finds a median can be a bulky and slow portion of a graphical processor. One reason for such inefficiencies is that determining the median value using a such traditional approaches, is relatively complex because these approaches sort the entire data set and thus not only finds the median, but also finds the largest value in the set, the second largest and so on including the smallest value in the set. Hence, this approach spends time and resources performing processes that provide more information than needed.

Other traditional approaches utilize an iterative procedure and sort parts or sub arrays of the data set, take the medians found in the sub-arrays and then sort again. Other approaches utilize weights or divide the input data set into ranges. All of these methods require a significant processing overhead. Generally, all of these traditional approaches are relatively complex. One reason for such complexity is that no appraisal of the m−1 values other than the median M is requested. Existing approaches which use comparators to compare each value with all other values as the “non-median” vales are eliminated in this process. Such a process having m values typically utilizes m(m−1)/2 comparators or more. A way to determine a median value from a set of values in an efficient manner would be desirable.

### SUMMARY OF THE INVENTION

Methods and apparatuses that can determining a median value from a set of m values are disclosed. The method can include receiving a set of values, separating the set of values into subsets where some subsets have multiple values and at least one other has a single value. The subsets having multiple variables can be sorted based on the magnitudes of the multiple values. The values from the subset can be processed to find sub-median values, and a median value can be determined from the set of values utilizing the sub-median values and sorted values. Other embodiments are also disclosed.

In another embodiment an apparatus for finding a median value is disclosed. The apparatus can include a first sorter to accept a first set of numbers, a second sorter to receive a second set of numbers, a first median module coupled to the first sorter and the second sorter to determine a first sub-median of the first and second set of numbers and a second median module coupled to the first sorter, the second sorter and the first median module to determine a second sub-median of the first and second set of numbers. The apparatus can also include a third median module coupled to the first sorter, the second sorter and the second median module where the third median module can provide one of a median or a sub-median of combination of the first and second set of numbers. The apparatus can also include a first and second buffer.

In other embodiments a method is disclosed that can find a median of a set of unsorted values. The approach can be used to find the median M within a single clock cycle. Utilizing a set having seven values the method can take one value of the set aside and can divide the rest of the set into two groups. The method can compare the set aside value with the lowest value of the first group and with the highest value of the second group and can provide a sub-median for these three values. In subsequent steps the sub median can be compared the lowest value of the remaining values of the first group and with the highest value of the remaining values of the second group and so on. Values which are identified to be not the median can be discarded. This approach can lead to a significantly reduced number of comparisons when finding a median for a data set.

### BRIEF DESCRIPTION OF THE DRAWINGS

In the following the disclosure is explained in further detail with the use of preferred embodiments, which shall not limit the scope of the invention.

FIG. 1 is a block diagram which shows in simplified form an apparatus that determines the median of seven input values according to the disclosure;

FIG. 2 is a block diagram of a module 100 called “3-median” which can determine the median M out of exact three input values D″(0), D″(1), and D″(2);

FIG. 3 shows the sub-median M” as a result of all possible combinations of values delivered by the comparators 131, 132, and 133 of the module 100 in FIG. 2 depending on the input values D″(0), D″(1), and D″(2);

FIG. 4 shows another embodiment of the present disclosure for five values D(0) to D(4);

FIG. 5 is a block diagram that shows in simplified form, details of a five-value median filter where the second value D(1) and the forth value D(3) are exchanged only for the sorting step;

FIG. 6 is a block diagram of the relevant part of a microprocessor architecture which can comprises parallel executing ALUs. An ALU can contain an implementation of an embodiment of the method and apparatus in order to find the median of a given set of values;

FIG. 7 is a block diagram of an apparatus to determine the median of five input values using buffers to increase clock speed; and

FIG. 8 is a flow diagram of a method to determine the median of a set of m input values.

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

While specific embodiments will be described below with reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

In the following description methods and apparatuses to determine a median M from an unsorted set of m values is disclosed. The method and apparatus can create groups from the set of values where one group has a single value or a “distinguished value” and the other groups have multiple values. In one embodiment the “other groups” have three values. For example, in an embodiment that processes seven values, three groups or sub-sets can be made, a subset with the distinguished value and two other groups or subsets with three values each. To process a set with eleven values a distinguished value can be one subset and there can be three subset each having three values (i.e. multi-value subsets).

After the data set is divided into subsets, the multiple value subsets can be sent to sorter modules that sort the subsets into a highest value of the subset and lowest value of the subset. These sorted values can be received by a series of three (3) median modules. The 3-median modules can be arranged in stages or arranged sequentially such that a set of seven values can be process by three 3 median modules in a sequential configuration. Each 3-median module can receive three values and can identify a sub-median of these three input values. In accordance with some embodiments, 3/2(m−1) comparators can be utilized to find a median value of a set of m values (not including comparators utilized in the sorting process, if any).

A traditional sorting system will utilize many more comparators than required by some of the embodiments disclosed herein. For example, many traditional systems utilize m(m−1)/2 comparators, where some embodiments disclosed herein utilize considerably fewer comparators in total (sorting included) which, reduces the number of comparators needed by one fifth for m=5 or by one third for m=9, compared to conventional approaches that sort the data set by comparing each value and providing a full sort of the data set prior to determining the median value.

As stated above, the system can determine the median M of a given set of m values, where the values are referred to herein as D(0) to D(m−1) and where m can be an odd number. For example, for a set having seven values (m=7) the disclosed methods and apparatuses can determine the median M for the set of values D(0) to D(6) and if the set of values D(0) to D(6) are (3,5,7,2,9,4,1) the middle value or median M would be 4.

The arrangements and teachings herein are described with reference to processing a set having seven values and five values. However, the size of the set should not be interpreted as a limiting factor as sets of any size could be processed utilizing the teachings herein. Alternately stated, arrangements are not limited to a certain number (m) of input values D(0) to D(m−1).

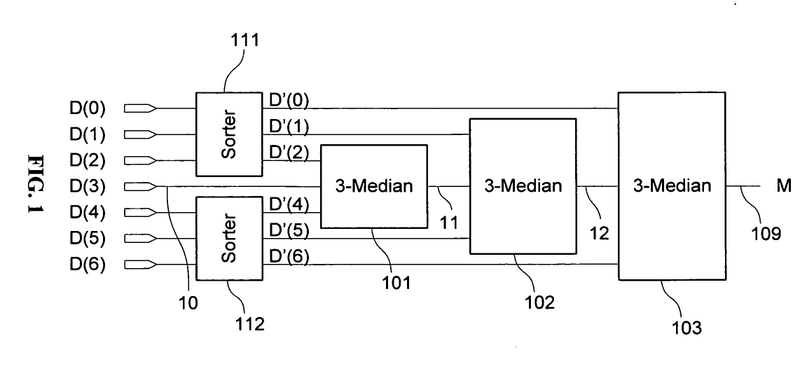

FIG. 1 shows a block diagram of at least a portion of a median processing system or apparatus. The apparatus can include two sorters 111 and 112 that can provide outputs to a sequence of median modules 101, 102, and 103 where each median module 101-103 can determine a median value from a set or subset having three values. The system can receive the values D(0) to D(6) and feed the values D(0), D(1), and D(2) to sorter 111. Inputs or values D(4), D(5), and D(6) can be fed into another sorter 112. The value D(3) can be a distinguished value 10 (a subset consisting of an unsorted single value that does not pass through a sorter). After the sort process the values are denoted with a “prime” (′) indicator. For example, D(0) can be referred to as D′(0).

The sorters 111 and 112 can sort the values they receive from a largest to smallest or from smallest to largest. In some embodiments, sorters 111 and 112 can sort the values in the set from lowest towards the top of the page (i.e. D′(0) and D(4) to the highest towards the bottom of the page (i.e. D′(2) and D′(6)). Therefore, the sorter 111 can receive D(0), D(1), and D(2) and can deliver D′(0), D′(1), and D′(2) where the values at the output of the sorter have the order D′(0)≦D′(1)≦D′(2). Sorter 111 can receive D(4), D(5), and D(6) and can deliver D′(4), D′(5), and D′(6) where the ordering can be D′(4)≦D′(5)≦D′(6). The highest value from sorter 111 (i.e. of D′(0)-D′(2)) can be sent to median module 101 and the lowest value from sorter 112 (i.e. of D′(4)-D′(6)) can be passed to median module 101.

The direction of sorting as described herein should not be understood as a limiting factor as sorting in different directions would not part from the scope of this disclosure. Each median module 101, 102 and 103 can each receive three values on their inputs and can deliver a median for the three input values. With the sorting “direction” described above, median module 101 can receive; D′(2) which can be the highest value of D′(0) to D′(2), D(3) which can be the subset with a single value or the distinguished value, and D′(4) which can be the lowest value of the subset D′(4) to D′(6).

Accepting these inputs, median module 101 can produce or determine value 11 which can be the median of D′(2), D′(3), and D′(4). D′(2), D′(3), and D′(4) can be also be considered as a subset of values. The value 11 can be called a “sub-median” because it is the median of three input values from three different subsets. Median module 102 can receive D′(1) which can be the second highest value of D′(0) to D′(2) assuming the direction of sorting as described above, the sub-median 11, D′(5) which can be the second highest value of D′(4) to D′(6) assuming the direction of sorting as described above, and the median module 102 can deliver a sub-median 12.

Median module 103 can receive; D′(0), which can be the lowest value from the set D′(0), D′(1), and D′(2) (assuming the direction of sorting as described above), a sub-median value 12, and D′(6) which can be the highest value of the set D′(4), D′(5) and D′(6) assuming the direction of sorting as described above. From these inputs median module can determine the median M 109 from the set of values (D(0)-D(6) provided at the input to the system. The disclosed system can be scalable and it can be appreciated that, to determine the median M of seven input values (m=7), a system having only two sorters each sorting three input values and three 3-median modules can be provide such a median function.

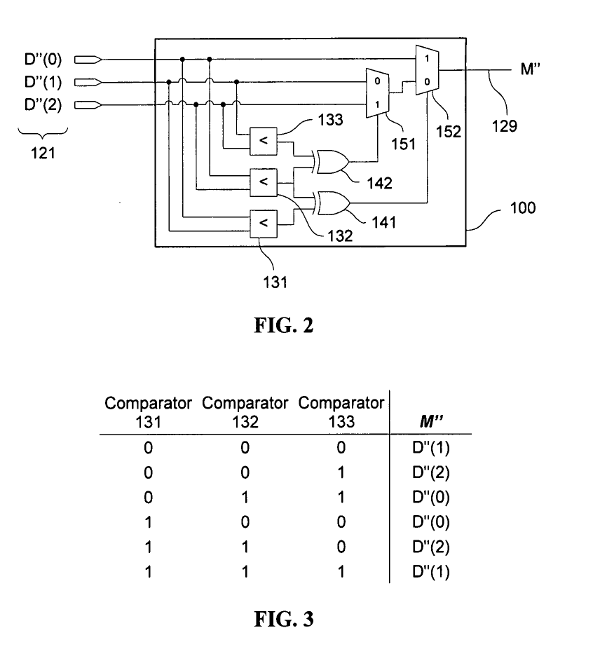

FIG. 2 depicts an embodiment 100 of a median module that can accept a set having three values and determine a median value of the set. Median modules can be scaled such that the median modules can accept more than three values and further, the described methods and apparatuses that determine the median of a given set of input values are not to be limited to median modules that can only accommodate three input values.

The median module 100 disclosed can include three comparators 131, 132 and 133 which can compare the three input values D″(0), D″(1), and D″(2) 121. Comparator 131 can produce a logic 1, if D″(0)<D″(1) or can produce a logic 0 if D″(0) is greater than or equal to D″(1). Comparator 132 can produce a logical 1, if D″(0)<D″(2) and else comparator 132 can produce a logical 0. The comparator 133 can deliver 1, if D″(1)<D″(2) else it can produce a logical 0. The results of the comparators 131, 132, and 133 can be are utilized to switch multiplexers 151 and 152 via exclusive OR (XOR) gates 141 and 142. When configured in a system, the median module 100 can deliver a sub-median 129 of the given input values 121.

It can be appreciated that a median module can be fast because it incorporates relatively little combinatorial logic, multiplexers, and comparators. It can be appreciated that the circuit configuration of FIG. 2 uses only three comparators, two XOR gates and two multiplexers where all of these components are relatively easy to build and can be designed with fast response times. It can also be appreciated that the illustrated configuration can operate at relatively clock speeds and while consuming a relatively small area on an integrated circuit.

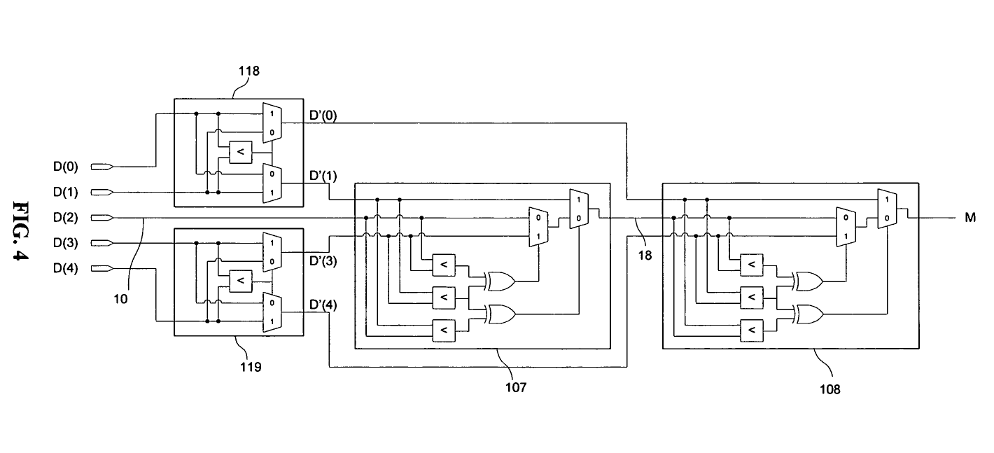

FIG. 3 is a table illustrating which input is will result as the median value or sub-median value at the output of the module 100 of FIG. 2 based on the outputs of comparators 131-133. Output “M” can be provided as a result of possible combinations of values output by the comparators 131, 132, and 133 as dictated by the input values D″(0), D″(1), and D″(2).

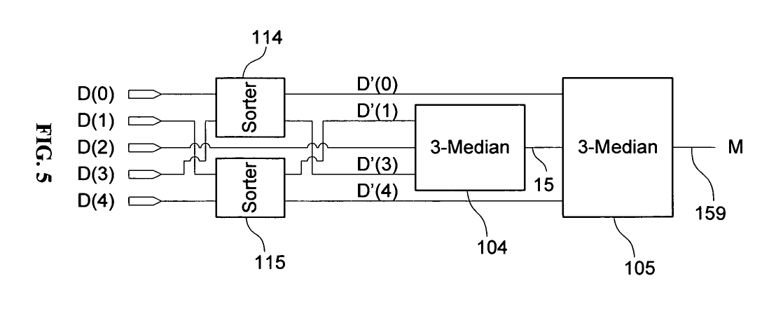

FIG. 4 shows another embodiment that can determine a median for a set of five numbers or values (i.e. D(0) to D(4)). One combinational logic configuration is illustrated for sorters 118 and 119 and for each median module 107 and 108. In this embodiment, both sorters 118 and 119 and both median modules 107 and 108 are substantially similar. In FIG. 4, both the first sorter module 118 and the second sorter module 119 can include a single comparator and two multiplexers. The logic devices shown provide a fast and efficient way to sort values by magnitude. The sorter 118 can receive the values D(0) and D(1), can sort them and can deliver D′(0) and D′(1) at an output, where D′(0)<D′(1). The sorter module 119 can receive the values D(3) and D(4), and can sort them and can deliver D′(3) and D′(4) at an output, where D′(3)<D′(4). In this embodiment, D(2) can be the subset with one value or can be the distinguished value 10.

The arranged values D′(0), D(1) and D′(3), D′(4) can be passed to median modules 107 and 108 where the median module 107 receives D′(1), D′(2), and D′(3) and median module 108 receives D′(0), the sub-median value 18 computed by the median module 107, and D′(4). The median M for the set of values D(0)-D(4) can then be determined by median module 108. In the embodiments shown in FIG. 4 the median modules 107 and 108 can be implemented using the circuit illustrated by module 100 as is shown in FIG. 2.

As described above, in some embodiments the sorting direction (top to bottom) of both the first and the second sorter can be the same. However, other embodiments such as the one illustrated for processing a set of five values can have a different way of sorting the two subsets of the set.

Referring to FIG. 5 in accordance with some embodiments, sorter 114 can sort D(0) and D(3) and sorter 115 can sort D(1) and D(4). The results of the first sorter 114 can be D′(0) and D′(3) whereas the results of the second sorter 115 can be D′(1) and D′(4). The subsequent procedure of determining the median value out of D′(0) to D′(4) can be similar to the approach shown in FIG. 4: the median module 104 can determine the sub-median 15 out of the values given by D′(1), D′(2), and D′(3) and median module 105 can determine the median M labeled 159 out of the values given by D′(0), the sub-median 15 as determined by the previous median module 104 and D′(4).

It can be appreciated that the embodiments described with reference to FIG. 5 as compared to the embodiments of FIG. 1 is that the sorters 114 and 115 have inputs that are cross coupled. The embodiments provide a different way to sort the input values D′(0) to D′(4) and can provide improved performance when a set having five values requires processing.

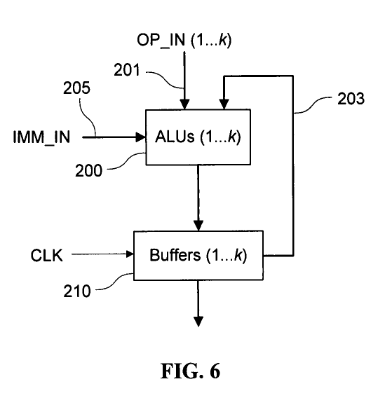

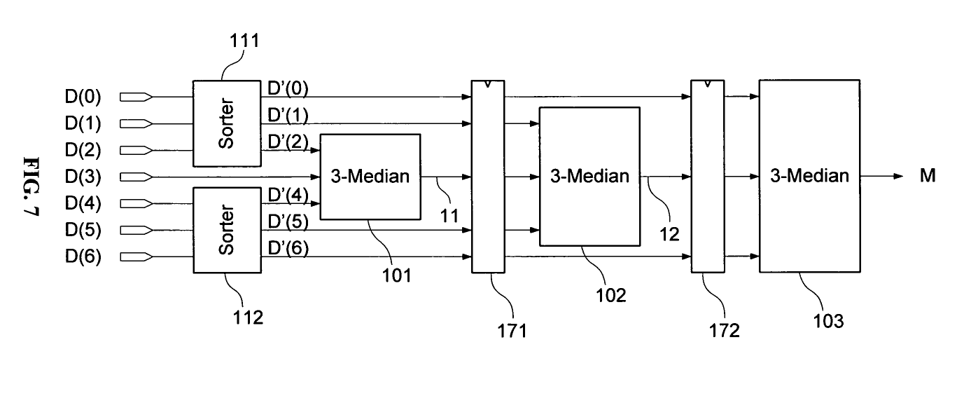

FIG. 6 shows a portion of a single instruction multiple data processing architecture having z parallel processing units or arithmetic logic units (ALUs) 200 whereas any of the ALUs 200 can execute instructions and implement a method to determine a median value from a set of values.

The parallel ALUs 200 can provide their results to buffers 210. Each ALU(k) can send results of a current operation to a corresponding buffer (k). Each of the z parallel ALUs 200 can receive an operand 201 herein denoted as OP_IN(k), whereas k denotes the number of the ALU. Moreover, each ALU(k) can receive any value 203 stored in the buffers 210 which can be the results of previous operations executed in the ALUs 200. In addition, each ALU(k) can receive an “immediate value” IMM_IN 205 which can be provided as part of a very long instruction (VLIW).

In some embodiments, the immediate value IMM_IN 205 can be the same for all ALUs 200 in a certain clock cycle. Hence, each ALU(k) of the ALUs 200 can receive a set of values and each ALU(k) can determine a median value from the set of values. Depending on the instruction word or VLIW provided to the processor (ALU(k)) the set of input values for the median calculation in each or any ALU(k) can be chosen from the multitude of values provided to ALU(k). Such a configuration is often utilized for processing streaming digital video data.

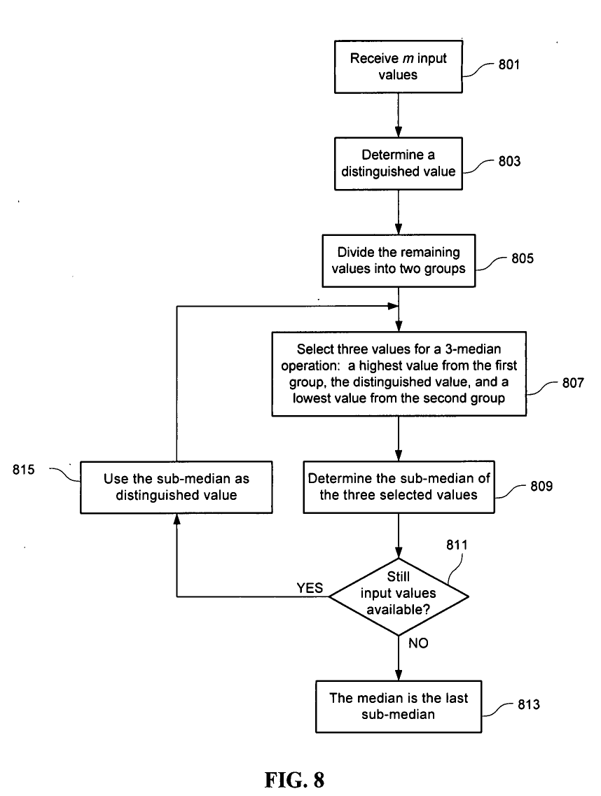

FIG. 7 shows a block diagram of another embodiment that allows the system to operate at an increased frequency. To allow the system to operate at higher frequencies buffers 171 and 172 can be placed between median modules 101 and 102 and between median modules 102 and 103. Median modules 101 can pass its output to a buffer 171 and the median module 102 can pass its output to a buffer 172. Buffer 171 can store some values needed to support median modules 102 and 103. Buffer 172 can store values needed to support median module 103.

The buffers can allow the system to operate at much higher clock speed because propagation times can be controlled. The propagation time from register 172 to the output (through module 103), propagation time through the module 102, and propagation time from the inputs through the modules 111, 112, and 101 can be controlled. Thus in one full cycle the values can be sorted and a median can be computed by module 101. In a next cycle other values can be are sorted and a median can be computed by module 101. In a next cycle, additional values can be sorted and a median can be computed by module 101, and a median can be computed by module 102, while in parallel a median is calculated by module 103.

The buffers 171 and 172 can break the flow of determining a median value into a series of sub-paths. Clocking of the buffers 171 and 172 allows each sub-path to be operated concurrently or in a parallel configuration where new data sets can be input to the system every clock cycle, and thus a median can be determined every clock cycle. As the sub-paths are shorter than the total path from the input to the output the system can be clocked at a speed that is sufficient to support the slowest sub-path. Additional buffers could be added to increase operating speed at the cost of additional overhead required by such buffers.

FIG. 8 shows a flow diagram of a method according to the present disclosure to determine the median of a set of m input values. As illustrated by block 801, a set of m input values can be received. A distinguished value can be determined from the set of input values as illustrated by block 803. As illustrated by block 805 the remaining values can be divided into a two additional subsets that can have the same number of values.

As illustrated by block 807 values can be selected to determine a sub-median: a highest value from the first subset, the distinguished value, and a lowest value from the second subset. The selected values can be removed from the groups and/or from the input values.

As illustrated by block 809 the sub-median of the three selected values can be determined using a comparison operation. As illustrated by decision block 811 it can be determined if still input values are available and the first group and/or the second group is not empty. In case input values are still available and/or the first and/or the second group are not empty, for a next iteration the sub-media determined by block 809 can be utilized as the distinguished value. The loop then can continue with execution of block 807. When no additional values are available and/or the first and/or the second group are empty, the median can be utilized as illustrated by block 813.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present disclosure, represent embodiments of the present disclosure.

The disclosed embodiments can take the form of an entirely hardware embodiment, an entirely software embodiment or an embodiment containing both hardware and software elements. In one embodiment, the arrangements can be implemented in software, which includes but is not limited to firmware, resident software, microcode, etc. Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The control module can retrieve instructions from an electronic storage medium. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present disclosure contemplates methods, systems, and media that can automatically tune a transmission line. It is understood that the form of the arrangements shown and described in the detailed description and the drawings are to be taken merely as examples. It is intended that the following claims be interpreted broadly to embrace all the variations of the example embodiments disclosed.

What is claimed is:

1. A method comprising:
receiving a set of values;
separating the set of values into subsets, some subsets having multiple values;
sorting the subsets having multiple variables based on the magnitudes of the multiple values;
processing values from the subsets to find sub-median values; and
finding a median of the set of values using the sub-median values and sorted values.

2. The method of claim 1, wherein processing further comprises processing values from three different subsets.

3. The method of claim 1, wherein one subset has a single number and other subsets contain more than one value and contain an equal quantity of values.

4. The method of claim 3, further comprising using the single number and sorted values from different subsets to determine a first sub-median value.

5. The method of claim 4, further comprising using the first sub-median value and sorted values from the different subsets to determine a second sub-median value.

6. The method of claim 4, further comprising buffering the first median value.

7. The method of claim 5, further comprising buffering the second median value.

8. The method of claim 1, further comprising processing sets of variable concurrenty by clocking components.

9. The method of claim 1, further comprising utilizing (m+1)²/4−1 comparators where m is a number of values in the set.

10. A method comprising:
receiving a set of numbers;
separating the set of numbers into at least a first sub-set of numbers and a second set of numbers and a selected number;
organizing the first subset of numbers and the second subset of numbers from smallest to largest to create a first and second organized set; and
determining a median value based on the selected variable and the first and second organized set.

11. The method of claim 10, further comprising determining sub medain values based an entry of the first organized set, an entry of the second organized set and the selected number.

12. The method of claim 10, further comprising determining a comprehensive median based on the second median, a maximum value of the first set of variables, a minimum value of the second set of variables.

13. The method of claim 10, further comprising cross coupling inputs to median modules.

14. An apparatus comprising:
a first sorter to accept a first set of numbers;
a second sorter to receive a second set of numbers;
a first median module coupled to the first sorter and the second sorter to determine a first sub-median of the first and second set of numbers; and
a second median module coupled to the first sorter, the second sorter and the first median module to determine a second sub-median of the first and second set of numbers.

15. The apparatus of claim 14, further comprising a third median module coupled to the first sorter, the second sorter and the second median module where the third median module provides one of a median or a sub-median or combination of the first and second set of numbers.

16. The apparatus of claim 14, further comprising a first buffer coupled to the first median module and the second median module.

17. The apparatus of claim 14, further comprising a second buffer coupled to the second median module and the third median module.

18. The apparatus of claim 14, wherein a median module accepts a number from the first set sorted by the first sorter and a number from the second set sorted by the sorter and a sub-median value.

19. The apparatus of claim 14, wherein the number from the first set has a lowest value of the first set of numbers and the number from the second set has a highest value of the second set.

20. The apparatus of claim 14, wherein the inputs to the first median module and the second median module are cross coupled.
